(19) United States
(12) Patent Application Publication
(10) Pub. No.: US 2024/0033680 A1
(43) Pub. Date: Feb. 1, 2024

(54) MEMBRANE ATTACHMENT TECHNIQUE

(71) Applicant: HYDROGEN MEM-TECH AS, Trondheim (NO)

(72) Inventors: Inge HJELKREM, Trondheim (NO); Martin SUUL, Trondheim (NO); Oystein ROGNES, Trondheim (NO); Stig Vemund GRABERG, Trondheim (NO); Thomas REINERTSEN, Trondheim (NO)

(73) Assignee: HYDROGEN MEM-TECH AS, Trondheim (NO)

(21) Appl. No.: 18/268,915

(22) PCT Filed: Dec. 17, 2021
(86) PCT No.: PCT/EP2021/086482

§ 371 Date: Jun. 21, 2023

(30) Foreign Application Priority Data
Dec. 23, 2020 (GB) 2020512.6

(51) Int. Cl. B01D 53/22; B01D 63/08; B01D 67/00; B01D 71/02

(52) U.S. Cl. CPC B01D 53/228; B01D 63/082; B01D 67/0072; B01D 71/02231; B01D 2256/16; B01D 2325/04

(57) ABSTRACT

Disclosed herein is a method of securing a membrane to a substrate, the method comprising: depositing a metal layer onto a surface of a substrate; and performing a bonding process that bonds a metal membrane onto the deposited metal layer.

### FIELD

The field of the invention is the provision of a membrane arrangement. Embodiments provide an improved technique for securing a metal membrane to a substrate.

### BACKGROUND

Hydrogen is increasingly being used as an energy source. An advantage of hydrogen is that it combusts to produce water and it is therefore a clean fuel. Applications in which hydrogen may be used as a combusted fuel include the powering of ships and as a domestic gas supply. Hydrogen may also be used in fuel cells that are an environmentally friendly alternative to conventional batteries.

An efficient form of hydrogen production is from syngas. Syngas may be produced by reforming natural gas. Syngas is a gas mixture that mostly comprises carbon monoxide, and/or carbon dioxide, and hydrogen. Syngas may also comprise amounts of carbon dioxide and other gasses, such as methane. A water gas shift reaction may also be performed on the syngas in order to increase the concentration of hydrogen in the gas mixture. To produce substantially pure hydrogen, it is necessary to separate the hydrogen from the other gasses in the gas mixture.

A known technique for separating hydrogen from other gasses is the use of a palladium alloy membrane. A gas mixture is passed through a pipe with the membrane as the pipe walls. The hydrogen diffuses through the membrane and is thereby separated from the other gasses in the gas mixture that are unable to pass through the membrane.

In known hydrogen separators, the membrane thickness is typically in the order of 100 micrometres. The rate at which hydrogen can pass through the membrane is inversely proportional to the membrane thickness and proportional to the membrane surface area.

The separation of hydrogen by such membranes is slow due to the large membrane thickness. In addition, the implementation costs are high because palladium is expensive.

There is a general need to improve known gas separation devices, and in particular, known membrane attachment techniques.

### SUMMARY OF INVENTION

According to a first aspect of the invention, there is provided a method of securing a membrane to a substrate, the method comprising: depositing a metal layer onto a surface of a substrate; and performing a bonding process that bonds a metal membrane onto the deposited metal layer.

Preferably, the deposited metal layer comprises silver, palladium, nickel and/or copper.

Preferably, the deposited metal layer has a thickness between 0.01 and 1 micrometre, preferably between 0.01 and 0.50 micrometres, and more preferably is about 0.1 micrometres or about 0.5 micrometres.

Preferably, wherein the metal membrane comprises palladium and/or a palladium alloy.

Preferably, depositing the metal layer comprises performing a sputtering process.

Preferably, the bonding process lasts between about 1 minute and about 350 hours, preferably between about 10 minutes and about 24 hours, more preferably between about 1 hours and about 12 hours such that the bonding process may last about 1 hour, and more preferably between about 6 hours and about 8 hours.

Preferably, the bonding process comprises applying heat and pressure in an enclosed environment.

Preferably, the applied pressure in the bonding process is between 1 and 30 barg, preferably between 5 and 20 barg, and more preferably is 5 barg.

Preferably, the applied pressure is a gas pressure.

Preferably, the applied pressure is a mechanically applied pressure.

Preferably, the enclosed environment comprises hydrogen gas.

Preferably, the enclosed environment comprises between 10 and 80 vol % hydrogen gas, preferably between 20 and 70 vol % hydrogen gas, and more preferably is 40 vol % hydrogen gas.

Preferably, the enclosed environment comprises substantially only an inert gas, such as nitrogen gas.

Preferably, the deposited metal layer comprises palladium; and the applied temperature in the bonding process is between 200° C. and 500° C., preferably between 400° C. to 450° C.

Preferably, the deposited metal layer comprises copper, silver or nickel; and the applied temperature in the bonding process is between 350° C. and 450° C., preferably is about 440° C.

Preferably, the metal membrane comprises one or more other metals than palladium.

Preferably, the metal membrane comprises silver; and preferably, the metal membrane is between 15 wt % to 40 wt % silver with substantially the rest of the metal membrane being palladium; and, more preferably, the metal membrane is about 77 wt % palladium and about 23 wt % silver.

Preferably, a thickness of the metal membrane is less than 10 micrometres, preferably between 0.2 and 5 micrometres, and more preferably between 1 and 4 micrometres.

According to a second aspect of the invention, there is provided a membrane arrangement comprising a metal membrane that is secured to a substrate, wherein the membrane arrangement is manufactured according to the method of the first aspect.

Preferably, the membrane arrangement is for separating a first gas from one or more other gasses in a gas separation device.

Preferably, the first gas is hydrogen and the one or more other gasses include nitrogen, methane, carbon monoxide and/or carbon dioxide.

According to a third aspect of the invention, there is provided a gas separation section for separating a first gas from one or more other gases in a separation device, the gas separation section comprising: a first membrane arrangement according to the second aspect that is substantially planar; a second membrane arrangement according to the second aspect that is substantially planar; the substrate of the first membrane arrangement has a first surface and a second surface, wherein the second surface is on an opposite side of the substrate of the first membrane arrangement than the first surface of the substrate of the first membrane arrangement; the substrate of the second membrane arrangement has a first surface and a second surface, wherein the second surface is on an opposite side of the substrate of the second membrane arrangement than the first surface of the substrate of the second membrane arrangement; and a mesh that is arranged between the second surface of the substrate of the first membrane arrangement and the second surface of the substrate of the second membrane arrangement; wherein: the membrane of the first membrane arrangement is secured to the first surface of the substrate of the first membrane arrangement; and the membrane of the second membrane arrangement is secured to the first surface of the substrate of the second membrane arrangement.

According to a fourth aspect of the invention, there is provided a separation device for separating a first gas from one or more other gases, the separation device comprising: an inlet for receiving a gas mixture comprising a first gas and one or more other gasses; a plurality of gas separation sections according to the third aspect, wherein the plurality of gas separation sections are arranged in a stack; a first outlet arranged to output the first gas that has passed through one or more of the membranes in the one or more gas separation sections; and a second outlet arranged to output at least one or more other gasses that have not passed through one or more of the membranes in the one or more separation sections.

According to a fifth aspect of the invention, there is provided a method of separating a first gas from a gas mixture comprising the first gas and one or more other gasses, the method comprising: feeding the gas mixture into a separation device according to the fourth aspect; receiving a first gas flow from the separation device that comprises substantially only the first gas; and receiving a second gas flow from the separation device that comprises at least the one or more other gasses than the first gas.

### LIST OF FIGURES

The accompanying drawings, which are incorporated herein and form part of the specification, illustrate embodiments of the invention and serve to clarify some aspects of embodiments of the invention and to enable a skilled person in the relevant art(s) to make and use embodiments of the invention.

FIGS. 1A, 1B and 1C show steps in a process for securing a membrane to a substrate according to an embodiment;

FIG. 2 shows a membrane arrangement according to an embodiment;

FIG. 3 is a cross-section of components of part of a separation device that may comprise membrane arrangements according to embodiments;

FIGS. 4A and 4B show a gas separation section that may comprise membrane arrangements according to embodiments;

FIG. 4C shows a stack of gas separation sections that may comprise membrane arrangements according to embodiments;

FIG. 5 shows part of a separation device that may comprise membrane arrangements according to embodiments; and

FIG. 6 is a flowchart of a method according to an embodiment.

### DETAILED DESCRIPTION OF INVENTION

WO 2020/012018 A1, the entirety of which is incorporated herein by reference, discloses a gas separation device that advantageously provides a large membrane surface area with the membrane thicknesses being small. In the gas separation device, a plurality of membranes for separating hydrogen are attached to a respective plurality of substrates. However, the attachment of thin membranes to substrates provide a number of technical challenges. When known techniques are used to attach the thin membranes to the substrates, problems that may be experienced include, for example, leakage and/or detachment of the membranes. Such problems increase the manufacturing cost and reliability of the gas separation device.

Embodiments provide improved techniques for securing a membrane to a substrate. Embodiments are particularly appropriate for attaching a thin membrane to a substrate. A preferred application of embodiments is in the construction of membrane arrangements for use in the gas separation device as disclosed in WO 2020/012018 A1.

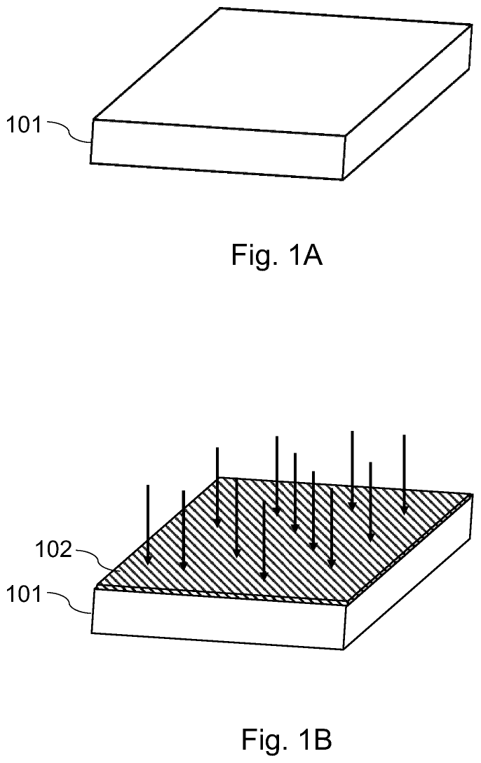

FIGS. 1A, 1B and 1C show steps in a membrane attachment technique according to embodiments.

The membrane attachment technique according to embodiments enables attachment of a membrane 103, that may be a thin membrane 103, to a substrate 101. Advantages of embodiments over known techniques may include one or more of a more secure attachment of a membrane 103 to a substrate 101, a reduced risk of gas leakage around the attached membrane, a lower risk of the membrane 103 detaching from the substrate 101, and an increased membrane lifetime.

The membrane 103 may be a palladium membrane. FIG. 1A shows a substrate 101 onto which a palladium membrane 103 will be secured. The substrate 101 may be made from metal, ceramic, polymer, or combinations thereof. Preferably, the substrate 101 is a sintered plate. Preferably, the substrate 101 is manufactured from AISI316L.

The substrate 101 according to embodiments may have the property that hydrogen can pass through it. The substrate 101 may be a porous material, or a material that is penetrable by hydrogen due to solid diffusion (e.g. mixed conductors of electronic and oxygen ion conducting and/or proton conducting ceramics or metals of the IVB and VB groups) or layered combinations thereof.

The inventors have realised that palladium has, as a material quality, the potential for growth into itself, as well as other materials. This is utilised in embodiments for improving the attachment of a palladium membrane 103 to a substrate 101.

In FIG. 1B, a very thin metal layer 102, that may comprise palladium, is first deposited on a surface of the substrate 101. The metal layer 102 may be deposited on the substrate through sputter deposition. The sputter deposition process may be performed in a substantial vacuum. The metal layer 102 may alternatively be deposited on the substrate by any other known depositing techniques.

The effect of the deposited metal layer 102 may be that surface peaks on the surface of the substrate 101 are covered with the deposited metal, that in the present embodiment comprises palladium. The amount of metal that is deposited may be substantially only what is required to cover the surface peaks. The metal layer 102 covering the surface peaks may, for example, have a thickness of between 0.01 and 1 micrometres, more preferably between 0.03 and 0.3 micrometres, more preferably between 0.1 and 0.25 micrometres, and more preferably the thickness is about 0.1 micrometres.

In FIG. 1C, a palladium membrane 103 is placed on the deposited metal layer 102 and the palladium membrane 103 is bonded to the deposited metal layer 102 by a bonding process, that may be referred to as a burn-in process. The burn-in process may cause the membrane 103 to grow into the deposited metal layer 102 on the substrate 101. The membrane 103 may thereby grow onto the surface peaks on the surface of the substrate 101, and consequently be secured to the substrate 101. Embodiments also include a palladium alloy membrane 103 similarly being placed on the deposited metal layer 102 and the palladium alloy membrane 103 similarly being bonded to the deposited metal layer 102 by the bonding process.

The membrane 103 according to embodiments may be less than 10 micrometres thick. That is to say, in a distance orthogonal to the plane of the membrane 103, the planar major surfaces of the membrane 103 are less than 10 micrometres apart from each other. The membrane 103 is preferably between 0.2 and 5 micrometres thick, and more preferably, between 1 and 4 micrometres thick.

The membrane 103 according to embodiments may be made of substantially only palladium. Alternatively, the membrane 103 may comprise palladium and one or more other metals than palladium.

The composition of the membrane 103 is preferably such that between 15% and 40% of its weight is silver with the rest of the weight being palladium. Preferably, the composition of the membrane 103 is such that between a fifth and a third of its weight is silver with the rest being palladium. More preferably, the composition of the membrane 103 is such that 77% of its weight is palladium and 23% of its weight is silver.

The membrane 103 may comprise palladium, silver and metal X and/or metal Y, where metal X is different to metal Y, and metal X and metal Y are both other metals than palladium and silver.

The most appropriate conditions of the burn-in process for bonding the membrane 103 to the deposited metal layer 102 may be dependent on both the composition of the deposited metal layer 102 and the composition of the membrane 103.

Suitable conditions of the burn-in process are described below according to a first embodiment. In the first embodiment, the deposited metal layer 102 is, or comprises, palladium, and the membrane 103 is, or comprises, palladium.

The burn-in process may last for up to about 350 hours, preferably the burn-in process lasts for up to about 14 days, preferably the burn-in process lasts less than about 24 hours, more preferably the burn-in process lasts between about 1 and about 12 hours, and preferably the burn-in process lasts between about 6 and about 8 hours. The burn-in process may last for about 1 hour. The burn-in process may last for between about 1 minute and about 350 hours, or between about 10 minutes and about 24 hours, or between about 30 minutes and about 1 hour.

The burn-in process may comprise applying heat and pressure in an enclosed environment. The burn-in process is preferably performed at a temperature up to about 650° C. or higher, preferably between about 200° C. and 500° C., preferably between about 300° C. and 450° C., more preferably between about 380° C. to about 480° C., and more preferably is at the lower end of between about 400° C. and 450° C. The burn-in process is preferably performed at a pressure between about 1 and about 30 barg, preferably between about 5 and about 20 barg, and more preferably is 5 barg. The processing time of the burn-in process may correlate with the applied temperature. For example, at higher applied temperatures shorter processing times may be sufficient. The applied pressure in the burn-in process may be an applied gas pressure. The applied pressure may alternatively be a mechanically applied pressure. A piston (or other device/surface) may, for example, be pressed onto the membrane so as to exert a pressure. For example, a piston may apply a pressure of about 2000 kN/m².

The burn-in process may be performed in an enclosed environment comprising hydrogen gas. The enclosed environment may comprise between about 10 and about 80 vol % hydrogen gas (so that there may be 70 vol % hydrogen gas), preferably between about 20 and about 70 vol % hydrogen gas, and more preferably there may be about 40 vol % hydrogen gas. A remainder of gas in the enclosed environment may be an inert gas, and is preferably nitrogen gas but could be any other inert gas, such as argon.

In a second embodiment of the burn-in process, the burn-in process may alternatively be performed in an enclosed environment that does not comprise hydrogen gas. The enclosed environment may comprise only an inert gas, such as nitrogen or argon. The second embodiment of the burn-in process may be performed at higher temperatures than the first embodiment of the burn-in process. For example, the second embodiment of the burn-in process may preferably be performed at temperatures up to about 650° C.

The use of hydrogen in the enclosed environment may improve the bonding between the substrate 101 and the membrane 103. However, an advantage of only using an inert gas in the enclosed environment is that it may be safer to heat the substrate 101 and membrane 103 in an oven.

The burn-in process may ensure a more secure attachment of the membrane 103 to the substrate 101 than what is achieved when known techniques are used. A membrane arrangement that comprises a membrane that is attached to a substrate according to embodiments may therefore be more robust than membrane arrangements manufactured according to known techniques.

Although the membrane attachment technique of embodiments has been described above in relation to a palladium membrane 103, embodiments also include the membrane 103 substantially comprising other metals than palladium. For example, embodiments may be used to attach an aluminium membrane 103 to a substrate.

Although the membrane attachment technique of embodiments has been described above in relation to the deposited metal layer 102 being, or comprising, palladium, the deposited metal layer 102 may comprise other metals, such as silver, copper and/or nickel, in addition to, or instead of, palladium. This is because palladium may grow into other materials than itself. In particular, palladium may grow into silver, copper, nickel, other metals and alloys thereof. The deposited metal layer 102 may therefore comprise the same metal(s), and/or different metal(s), as the membrane 103. For example, in an embodiment the deposited metal layer 102 may be silver, copper and/or nickel and the membrane 103 may be palladium. Embodiments also include the membrane 103 not being a palladium membrane and the deposited metal layer 102 comprising no palladium.

According to another embodiment, the deposited metal layer 102 is, or comprises, copper, and the membrane 103 is, or comprises, palladium. In the present embodiment, the embodiment, the thickness of the deposited metal layer 102 may be in the range of about 0.01 to 1 micrometre, and is preferably about 0.25 micrometres, and is more preferably about 0.1 micrometres. A suitable temperature of the burn-in process of the present embodiment is in the range 350° C. to 450° C., preferably the temperature is 440° C., and more preferably the temperature is 400° C. The duration of the burn-in process of the present embodiment may be up to 24 hours, and is preferably 6 to 8 hours. The pressure of the burn-in process of the present embodiment may be between about 5 and 20 barg, and is preferably 5 barg. The burn-in process may be performed in an enclosed environment comprising substantially only an inert gas, such as nitrogen gas or argon gas.

According to another embodiment, the deposited metal layer 102 is, or comprises, silver, and the membrane 103 is, or comprises, palladium. In the present embodiment, the embodiment, the thickness of the deposited metal layer 102 may be in the range of about 0.01 to 1 micrometre, and is preferably about 0.25 micrometres, and is more preferably about 0.1 micrometres. The conditions of the burn-in process in the present embodiment may be as described above for when the deposited metal layer 102 is, or comprises, copper. Alternatively, the conditions of the present embodiment may differ by a lower burn-in temperature being used.

According to another embodiment, the deposited metal layer 102 is, or comprises, nickel, and the membrane 103 is, or comprises, palladium. In the present embodiment, the embodiment, the thickness of the deposited metal layer 102 may be in the range of about 0.01 to 1 micrometre, and is preferably about 0.25 micrometres, and is more preferably about 0.1 micrometres. The conditions of the burn-in process in the present embodiment may be as described above for when the deposited metal layer 102 is, or comprises, copper. Alternatively, the conditions of the present embodiment may differ by a lower burn-in temperature being used.

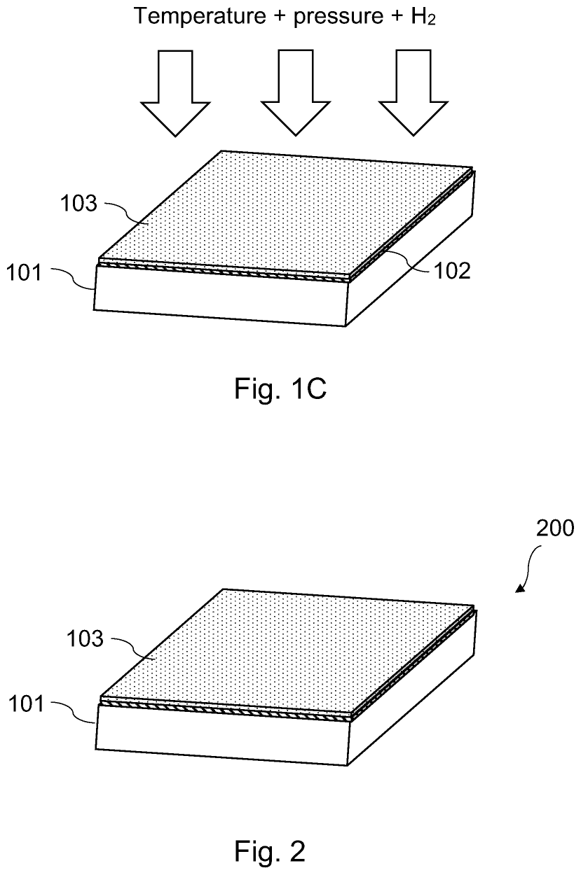

FIG. 2 shows a membrane arrangement 200 according to embodiments. The membrane arrangement 200 comprises a substrate 101 and a membrane 103 secured to the substrate 101 by the membrane attachment technique described above in relation to FIG. 1.

The membrane arrangement 200 according to embodiments can be used to separate one or more gasses from a gas mixture. The membrane 103 has the property that at least one gas can pass through it, while one or more other gasses in the gas mixture cannot pass through it.

As the membrane attachment technique according to embodiments enables secure attachment of thin membranes 103 to substrates 101, the membrane arrangement 200 according to embodiments is reliable and may support an high rate of transmission of a gas passing through the membrane 103 without leakage.

In an embodiment, the membrane arrangement 200 may be used to separate hydrogen gas from syngas. A water gas shift reaction may have been performed on the syngas and so the reference to syngas is to be understood as being any gas mixture comprising hydrogen and one or more of carbon monoxide, carbon dioxide, steam and other gasses, such as methane. Embodiments include the gas mixture being substantially a mixture of only carbon dioxide and hydrogen.

A membrane arrangement 200 comprising a palladium membrane may be particularly suitable for separating hydrogen gas from syngas. Accordingly, hydrogen may be separated from a mixture of hydrogen and carbon monoxide and/or carbon dioxide. The membrane arrangement 200 comprising a palladium membrane may more generally be used to separate hydrogen gas from any mixture of hydrogen gas and another gas. For example, the membrane arrangement 200 comprising a palladium membrane may be used to separate hydrogen from a mixture of hydrogen and methane, a mixture of hydrogen and carbon dioxide, or a mixture of hydrogen and nitrogen.

A membrane arrangement comprising a membrane other than a palladium membrane may be particularly suitable for separating a gas different from hydrogen from a gas mixture. Embodiments can therefore be used to separate any of one or more gasses that can flow through the membrane from a gas mixture.

Embodiments have been described with the membrane arrangement 200 comprising a planar membrane 103 secured on a planar surface of the substrate 101. Although this is a preferred implementation of embodiments, embodiments also include a membrane arrangement 200 with a tubular membrane 103 secured on a tubular surface of a substrate 101. The membrane arrangement 200 would have a tubular or cylindrical structure but otherwise may be substantially as described above for planar membranes.

The membrane arrangement 200 may have any suitable shape, for example a square-shaped plane, a circular plane, an annular plane or a rectangular plane.

In the membrane arrangement 200 according to embodiments, the membrane 103 is bonded directly to the substrate 101 through the burn-in process into the deposited metal layer 102. This minimises the transportation distance, and transportation resistance, of hydrogen (or any other gas that is to be separated) as it passes through the membrane. The rate of gas transmission and thereby the rate of gas separation may therefore be increased.

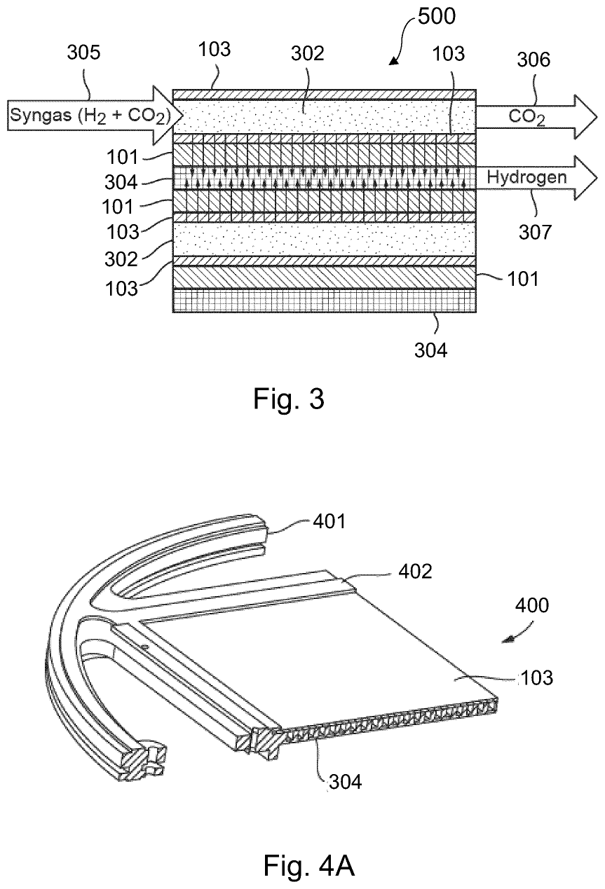

FIG. 3 is a cross-section of a part of a separation device 500 as disclosed in WO 2020/012018 A1, the entirety of which is incorporated herein by reference. The separation device 500 may comprise membrane arrangements in which the membrane is secured to a substrate according to the techniques of the above described embodiments.

The separation device 500 of FIG. 3 will be described in an example application of hydrogen separation from syngas. As shown by the text in the large arrows in FIG. 3, embodiments include the input gas mixture being substantially a mixture of only carbon dioxide and hydrogen. A first output may be a stream of substantially only carbon dioxide. A second output, that is separate from the first output, may be a stream of substantially only hydrogen.

The separation device 500 comprises a plurality of first channels 302 and a plurality of second channels 304. Each of the first channels 302 are formed between planar membranes 103 that are walls of the first channel 302. One or more planar membranes 103 are secured to a respective substrate 101 according to the membrane attachment technique discussed in relation to FIGS. 1A-1C. Thus, one or more pairs of planar membranes 102 and respective substrates 101 form membrane arrangements 200 according to embodiments.

Each substrate 101 is formed on a steel mesh on the other side of the substrate 101 from the membrane 103. The mesh is provided within each of a plurality of second channels 304. Hydrogen is able to pass through the membrane 103, pass through the substrate 101 and flow along each second channel 304, as the mesh structure comprises gas flow paths for the hydrogen. The gas input to each of the first channels 302 is syngas. The gas that is output from each of the first channels 302 the referred to herein as a retentate gas. Retentate gas is the remaining contents of the input syngas into a first channel 302 after some, or all, of the hydrogen in the input syngas gas has passed through a membrane 103. The output gas from a second channel 304 comprises hydrogen that has passed through a membrane 103. Each first channel 302 has an inlet 305 for syngas at one end of the channel and an outlet 306 for retentate at the other end of the first channel 302.

At least one end of each second channel 304 is an outlet 307 for hydrogen. Embodiments also include more than one end of the second channel 304 being an outlet for hydrogen. In use, syngas is provided at the inlet of one or more of the first channels 302 and passes through each of these first channels 302 towards the respective outlets of the first channels 302. As the syngas passes through each first channel 302, hydrogen in the syngas passes through the planar membrane 103 walls of the channel. The retentate gas that passes through the outlet of each first channel 302 has a lower concentration of hydrogen than the syngas gas at the inlet of the first channel 302 due to the hydrogen passing through the membrane 103. Preferably, substantially no hydrogen is present in the gas that passes through the outlet of each first channel 302. The hydrogen that passes through the membrane 103 passes through the substrate 101, into one of the second channels 304 and out of an outlet 307 of the second channel 304.

As previously discussed, one or more pairs of membranes and respective substrates in the gas separation device of FIG. 3 may be a membrane arrangement 200 according to embodiments. This reduces the risk of leakage in the membrane arrangement, reduces the risk of detachment of the membrane from the substrate and thereby increases the lifetime of the membrane arrangement.

It is to be understood that the membrane arrangement 200 according to embodiments may be used in gas separation devices with a different structure than the separation device 500 in FIG. 3. The membrane arrangement according to embodiments may be used in a gas separation device that comprises only one first channel 302 and/or only one second channel 304. The membrane arrangement according to embodiments may be used in a gas separation device that does not comprise a mesh 304.

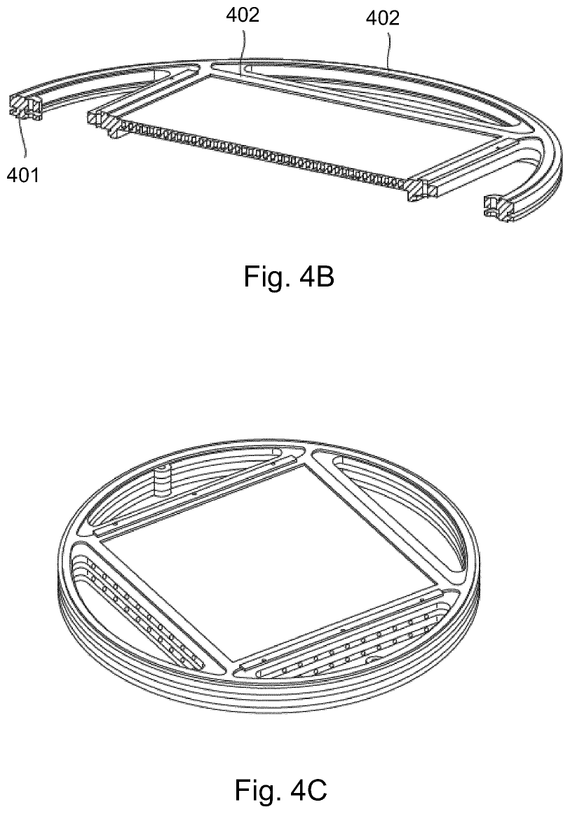

FIGS. 4A and 4B show part of an implementation of a single gas separation section 400 of a separation device 500, as disclosed in WO 2020/012018 A1. Gas separation sections 400, as shown in FIGS. 4A and 4B, provide the parts of the structure as described earlier with reference to FIG. 3. Each gas separation section 400 comprises two planar membranes 103 with each planar membrane 103 provided on a side of a substrate 101. One or more of the membranes 103 are attached to the respective substrate 101 by the membrane attachment technique according to embodiments to form membrane arrangements 200. The other side of each substrate 101 is connected to a steel mesh. The mesh defines a second channel 304 between the membranes 103 for collecting hydrogen.

Each gas separation section 300 may comprise a hydrogen frame 401. The hydrogen frame 401 provides a structural support for a mesh. The mesh supports a membrane arrangement 200

As shown in FIGS. 4A and 4B, gaskets 303 may be provided. Gaskets 303 may be gas seals. A gasket 303 may be provided that covers all of the edges of each membrane 103 so that gas in the first channel 302 is prevented from flowing around the ends of the membrane 103 into the second channel 304, and vice versa. The only gas flow between the first channel 302 and second channel 304 is therefore gas that has passed through the membrane 103, and not around the edges of the membrane 103.

FIG. 4C shows two gas separation sections 400 with one stacked on top of the other.

Between adjacent gas separation sections 400 a gas tight seal, e.g. a polymeric/rubber seal, may be provided for preventing any undesired gas flow paths.

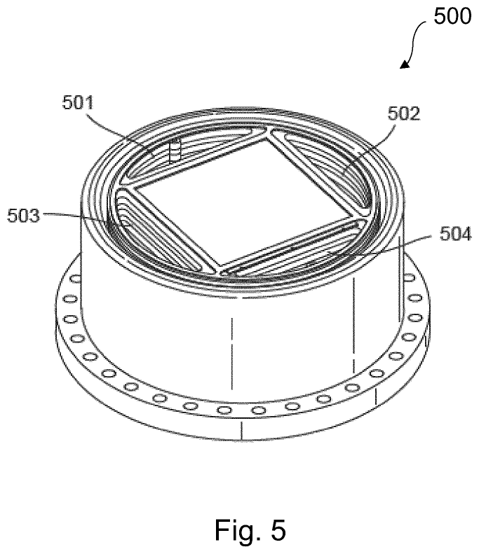

FIG. 5 shows part of a gas separation device 500 according to an embodiment. The separation device 500 according to embodiments preferably comprises a plurality of gas separation sections 400.

The segment shaped holes of the plurality of gas separation sections 400 may align to form four inlet/outlet channels 501, 502, 503, 504 through the stack of gas separation sections 400. Each inlet/outlet channel 501, 502, 503, 504 may be in fluid communication with at least one input or output port of the separation device 500. The inlet/outlet channels may therefore provide flow paths for the input syngas, the output hydrogen and the output retentate gas.

For example, channel 502 may be an inlet channel that provides a flow path of syngas from an input port for syngas. The syngas may flow into and along channel 502, in a direction that is orthogonal to the plane of each gas separation section 400, and into any of the gas separation sections 400. Channel 503 may be an outlet channel that provides a flow path of the retentate gas to an output port for retentate gas. The retentate gas flows out of each first channel 302 into channel 503 and then, in a direction that is orthogonal to the plane of each gas separation section 400, along channel 503 to an output port.

One, or both, of channels 501 and 504 may be outlet channels of hydrogen that provide flow paths of hydrogen to one or more outputs for hydrogen. The hydrogen may flow out of each second channel 304 into at least one, or both, of channels 501 and 504, and then, in a direction that is orthogonal to the plane of each gas separation section 400, along one, or both, of channels 501 and 504 to at least one output port for hydrogen.

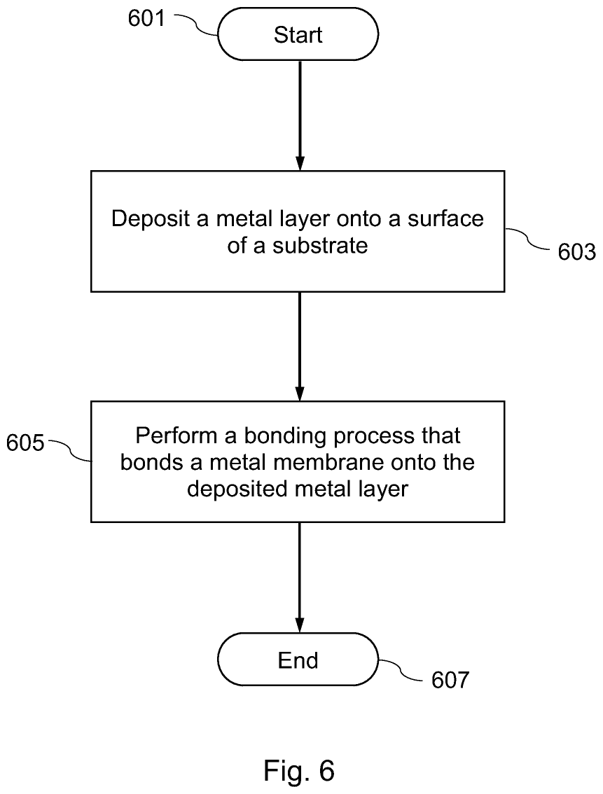

FIG. 6 is a flowchart showing a method according to embodiments. In step 601, the method begins. In step 603, a metal layer is deposited onto a surface of a substrate. In step 605, a bonding process that bonds a metal membrane onto the deposited metal layer is performed. In step 607, the method ends.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1-23. (canceled)

24. A method of securing a membrane to a substrate in the process of forming a single layer membrane structure for separating a first gas from one or more other gasses in a gas separation device, the method comprising:
depositing a metal layer onto a surface of a substrate; and
performing a bonding process that bonds a metal membrane onto the deposited metal layer.

25. The method according to claim 24, wherein the deposited metal layer comprises palladium, silver, nickel and/or copper.

26. The method according to claim 24, wherein the deposited metal layer has a thickness between 0.01 and 1 micrometre, preferably between 0.01 and 0.50 micrometres, and more preferably is about 0.1 micrometres or about 0.5 micrometres.

27. The method according to claim 24, wherein the metal membrane comprises palladium and/or a palladium alloy.

28. The method according to claim 24, wherein depositing the metal layer comprises performing a sputtering process.

29. The method according to claim 24, wherein the bonding process lasts between about 1 minute and about 350 hours, preferably between about 10 minutes and about 24 hours, more preferably between about 1 hour and about 12 hours such that the bonding process may last about 1 hour, and more preferably between about 6 hours and about 8 hours.

30. The method according to claim 24, wherein the bonding process comprises applying heat and pressure in an enclosed environment.

31. The method according to claim 24, wherein the bonding process comprises applying heat and pressure in an enclosed environment; and
wherein the applied pressure in the bonding process is between 1 and 30 barg, preferably between 5 and 20 barg, and more preferably is 5 barg.

32. The method according to claim 24, wherein the bonding process comprises applying heat and pressure in an enclosed environment;
wherein the applied pressure in the bonding process is between 1 and 30 barg, preferably between 5 and 20 barg, and more preferably is 5 barg; and
wherein the applied pressure is a gas pressure.

33. The method according to claim 24, wherein the bonding process comprises applying heat and pressure in an enclosed environment;
wherein the applied pressure in the bonding process is between 1 and 30 barg, preferably between 5 and 20 barg, and more preferably is 5 barg; and
wherein the applied pressure is a mechanically applied pressure.

34. The method according to claim 24, wherein the bonding process comprises applying heat and pressure in an enclosed environment;
wherein the enclosed environment comprises hydrogen gas; and
wherein the enclosed environment comprises between 10 and 80 vol % hydrogen gas, preferably between 20 and 70 vol % hydrogen gas, and more preferably is 40 vol % hydrogen gas.

35. The method according to claim 24, wherein the bonding process comprises applying heat and pressure in an enclosed environment; and
wherein the enclosed environment comprises substantially only an inert gas, such as nitrogen gas.

36. The method according to claim 24, wherein the bonding process comprises applying heat and pressure in an enclosed environment;
the deposited metal layer comprises palladium; and
the applied temperature in the bonding process is between 200° C. and 500° C., preferably between 400° C. to 450° C.

37. The method according to claim 24, wherein the bonding process comprises applying heat and pressure in an enclosed environment;
the deposited metal layer comprises copper, silver or nickel; and
the applied temperature in the bonding process is between 350° C. and 450° C., and preferably is about 440° C.

38. The method according to claim 24, wherein the metal membrane comprises one or more other metals than palladium.

39. The method according to claim 24, wherein the metal membrane comprises silver; and preferably, the metal membrane is between 15 wt % to 40 wt % silver with substantially the rest of the metal membrane being palladium; and, more preferably, the metal membrane is about 77 wt % palladium and about 23 wt % silver.

40. The method according to claim 24, wherein a thickness of the metal membrane is less than 10 micrometres, preferably between 0.2 and 5 micrometres, and more preferably between 1 and 4 micrometres.

41. A membrane arrangement comprising a metal membrane that is secured to a substrate, wherein:
the metal membrane is comprised by single layer membrane structure for separating a first gas from one or more other gasses in a gas separation device, and the manufacture of the membrane arrangement comprises:
depositing a metal layer onto a surface of a substrate; and
performing a bonding process that bonds a metal membrane onto the deposited metal layer.

42. The membrane arrangement according to claim 41, wherein the first gas is hydrogen and the one or more other gasses include nitrogen, methane, carbon monoxide and/or carbon dioxide.

43. A separation device for separating a first gas from one or more other gases, the separation device comprising:
an inlet for receiving a gas mixture comprising a first gas and one or more other gasses;
a plurality of gas separation sections, wherein the plurality of gas separation sections are arranged in a stack;
a first outlet arranged to output the first gas that has passed through one or more of the membranes in the one or more gas separation sections; and
a second outlet arranged to output at least one or more other gasses that have not passed through one or more of the membranes in the one or more separation sections;
wherein each gas separation section comprises:
a first membrane arrangement that is substantially planar;
a second membrane arrangement that is substantially planar;
the substrate of the first membrane arrangement has a first surface and a second surface, wherein the second surface is on an opposite side of the substrate of the first membrane arrangement than the first surface of the substrate of the first membrane arrangement;
the substrate of the second membrane arrangement has a first surface and a second surface, wherein the second surface is on an opposite side of the substrate of the second membrane arrangement than the first surface of the substrate of the second membrane arrangement; and
a mesh that is arranged between the second surface of the substrate of the first membrane arrangement and the second surface of the substrate of the second membrane arrangement;
wherein:
the membrane of the first membrane arrangement is secured to the first surface of the substrate of the first membrane arrangement; and
the membrane of the second membrane arrangement is secured to the first surface of the substrate of the second membrane arrangement; and
wherein:
the first membrane arrangement comprises a metal membrane that is secured to a substrate, wherein the metal membrane is comprised by single layer membrane structure for separating a first gas from one or more other gasses in a gas separation device, and the manufacture of the membrane arrangement comprises depositing a metal layer onto a surface of a substrate and performing a bonding process that bonds a metal membrane onto the deposited metal layer; and
the second membrane arrangement comprises a metal membrane that is secured to a substrate, wherein the metal membrane is comprised by single layer membrane structure for separating a first gas from one or more other gasses in a gas separation device, and the manufacture of the membrane arrangement comprises depositing a metal layer onto a surface of a substrate and performing a bonding process that bonds a metal membrane onto the deposited metal layer.
